(19) United States
(12) Patent Application Publication
(10) Pub. No.: US 2009/0195034 A1
(43) Pub. Date: Aug. 6, 2009

(54) SUNSHADE ASSEMBLY

(75) Inventor: Paul Lin, Tainan Hsien (TW)

Correspondence Address: OCCHIUTI ROHLICEK & TSAO, LLP, 10 FAWCETT STREET, CAMBRIDGE, MA, 02138, US

(73) Assignee: MacAuto Industrial Co., Ltd., Tainan Hsien (TW)

(21) Appl. No.: 12/024,473

(22) Filed: Feb. 1, 2008

(51) Int. Cl. B60J 7/043

(52) U.S. Cl. 296/216.01; 296/97.8

(57) ABSTRACT

A sunshade assembly includes a pair of rails each having an inner wall defining a recess therewithin, a screen unit, and a pair of positioning units. The screen unit includes a roller, and a screen having a fixed end secured to the roller, a free end, and opposite peripheral edge portions. Each positioning unit includes a slide member and a lock member. The slide member is mounted to a respective one of the peripheral edge portions and extends into the recess to be slidably disposed therein. The slide member has an inclined surface positioned in the recess. The lock member is disposed between the inclined surface and the inner wall, and is operable between a locked state where the lock member is clamped between the inclined surface and the inner wall, and a released state where the lock member is loosely held between the inclined surface and the inner wall.

### BACKGROUND OF THE INVENTION

1. Field of the Invention

The invention relates to a sunshade assembly, more particularly to a sunshade assembly for a vehicle and having a screen that may be extended to and maintained at any desired position.

2. Description of the Related Art

Taiwanese Utility Model No. M257288 shown in FIGS. 1 and 2 discloses a sunshade assembly 1 that is extendable to and maintainable at any desired position. This conventional sunshade assembly 1 includes a pair of spaced-apart rails 11, a screen unit 12, a pair of spaced-apart retraction units 13, and a pair of rotational units 14.

Each rail 11 includes a recessed wall 112 defining a recess 111, a channeled wall 114 defining a channel 113, and an installation wall 115 distal from the screen unit 12. The recesses 111 of the pair of rails 11 are opposite to each other.

The screen unit 12 includes a pair of spaced-apart fixtures 121, a rotatable connecting rod 122 disposed between the pair of fixtures 121, a shaft 123 sleeved on and co-rotatable with the connecting rod 122, a pair of spaced-apart connecting members 124 for interconnecting the connecting rod 122 and the shaft 123 so as to enable co-movement of the connecting rod 122 and the shaft 123, an extendable screen 125 wound on the shaft 123, and a handle 127 attached to a free end 126 of the screen 125.

Each retracting unit 13 has a rotatable pulley 131 sleeved on the connecting rod 122, a guiding pulley 132 provided on the installation wall 115 of a respective one of the rails 11, and a rope 133. One end of the rope 133 is wound on the corresponding rotatable pulley 131, and the other end of the rope 133 loops over the corresponding guiding pulley 132 after being passed through the channel 113 in the respective one of the rails 11 and is finally fixed to the handle 127.

When a user pulls on the handle 127 in an extension direction 15, the connecting members 124, which are fixed to the shaft 123, are brought along to co-rotate with the shaft 123. Further, since the connecting members 124 are connected to the rotatable pulleys 131 through the rotational units 14, during the extension of the screen 125, the rotatable pulleys 131 also rotate, thereby allowing the ropes 133 to be wound on the rotatable pulleys 131. On the other hand, when the screen 125 is retracted in a retraction direction 16, the handle 127 will bring said other end of each of the ropes 133 in proximity to the shaft 123, such that the rotatable pulleys 131 are rotated through the ropes 133. Since the rotatable pulleys 131 are connected to the connecting members 124 through the rotational units 14, such movement of the rotatable pulleys 131 causes the connecting members 124 and the shaft 123 to rotate. As a result, the screen 125 is wound on the shaft 123.

Although the above said conventional sunshade assembly 1 can be extended to and maintained at any position, such a design requires cooperation among the ropes 133, the rotatable pulleys 131, the guiding pulleys 132, the rotational units 14, and the connecting members 124 in order to achieve the desired function of extending to an arbitrary position. However, not only are these cooperating components complicated in structure, which makes assembly difficult, but also, with the dependency on the ropes 133 to connect these components together, the sunshade assembly 1 is prone to extension and retraction failures.

### SUMMARY OF THE INVENTION

It is an object of the present invention to provide a sunshade assembly that can overcome the above drawbacks of the prior art.

The sunshade assembly of this invention includes a pair of rails each having an inner wall defining a recess therewithin, a screen unit, and a pair of positioning units. The screen unit includes a roller operable to continuously exert a retraction force, and a screen having a fixed end secured to the roller to thereby receive the retraction force, a free end opposite to the fixed end, and opposite peripheral edge portions. Each positioning unit includes a slide member, and a lock member. The slide member is mounted to a respective one of the peripheral edge portions of the screen at the free end of the screen, and extends into the recess in a respective one of the rails to be slidably disposed therein. The slide member has an inclined surface positioned in the recess. The lock member is disposed between the inclined surface of the slide member and the inner wall of the respective one of the rails, and is operable between a locked state where the lock member is clamped between the inclined surface and the inner wall, and a released state where the lock member is loosely held between the inclined surface and the inner wall.

### BRIEF DESCRIPTION OF THE DRAWINGS

Other features and advantages of the present invention will become apparent in the following detailed description of the preferred embodiment with reference to the accompanying drawings, of which:

FIG. 1 is a partly exploded perspective view of a conventional sunshade assembly;

FIG. 2 is a sectional view of the conventional sunshade assembly of FIG. 1, illustrating the conventional sunshade assembly in an assembled state;

FIG. 3 is a perspective view of the preferred embodiment of a sunshade assembly in accordance with the present invention;

FIG. 4 is a partly sectional view of the preferred embodiment of the sunshade assembly;

FIG. 5 is a perspective view of the preferred embodiment shown in a state mounted on a sunroof of a vehicle;

FIG. 6 is a fragmentary exploded perspective view of the preferred embodiment to illustrate the interrelationship between a rail and a positioning unit;

FIG. 7 is a fragmentary sectional view of the preferred embodiment to illustrate a lock member at an intermediate position between high and low points of the positioning unit;

FIG. 8 is a view similar to FIG. 7, but illustrating the lock member at the high point; and

FIG. 9 is a view similar to FIG. 7, but illustrating the lock member at the low point.

### DETAILED DESCRIPTION OF THE PREFERRED EMBODIMENT

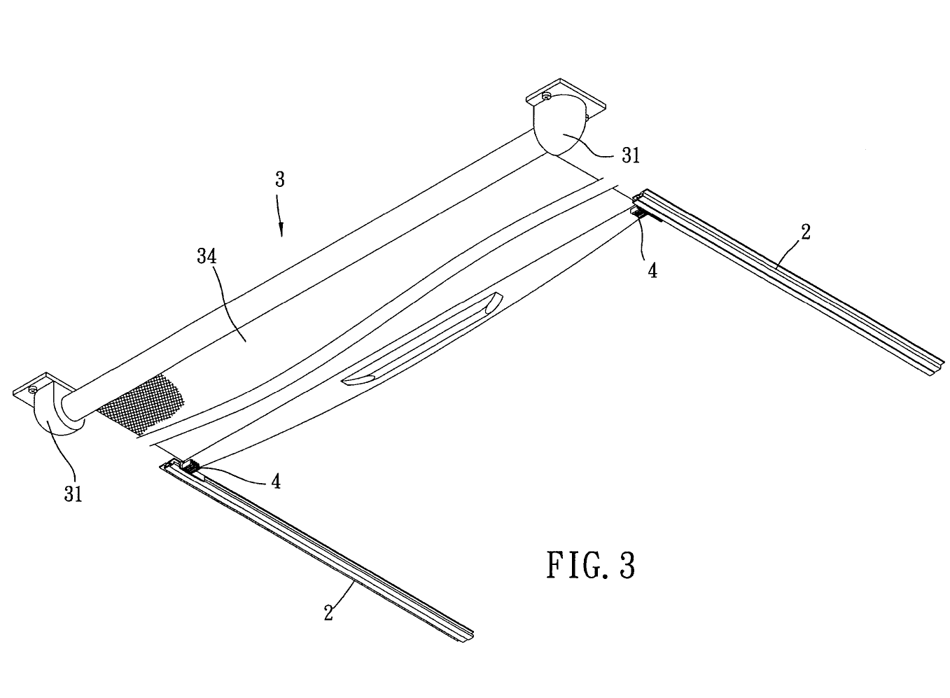

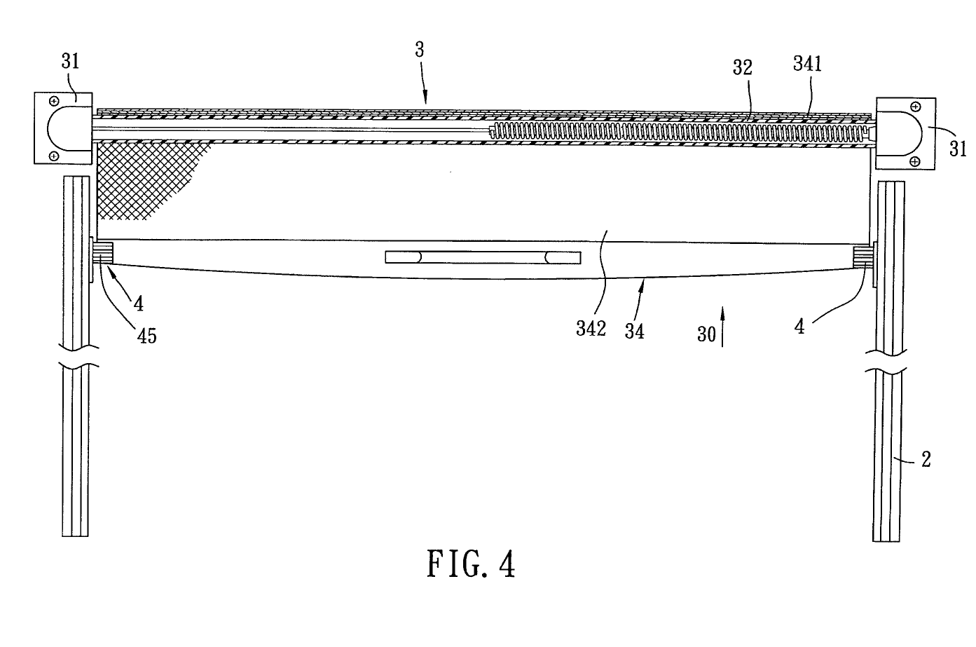

Referring to FIGS. 3 to 6, a sunshade assembly according to the preferred embodiment of the present invention may be assembled beneath a sunroof 9 of a vehicle 90 to thereby cover the sunroof 9. The sunshade assembly includes a pair of rails 2 each having an inner wall defining a recess 22 therewithin, a screen unit 3, and a pair of positioning units 4. The screen unit 3 includes a pair of spaced-apart fixtures 31, a roller 32 rotatably mounted between the pair of fixtures 31 and operable to continuously exert a retraction force 30 (see FIG. 4), and a screen 34 having a fixed end 341 secured to the roller 32 to thereby receive the retraction force 30, a free end 342 opposite to the fixed end 341, and opposite peripheral edge portions. Since the retraction mechanism of the roller 32 for generating the retraction force 30 is known to those skilled in the art and is not a key feature of the present invention, a detailed description of the same will be dispensed with herein for the sake of brevity.

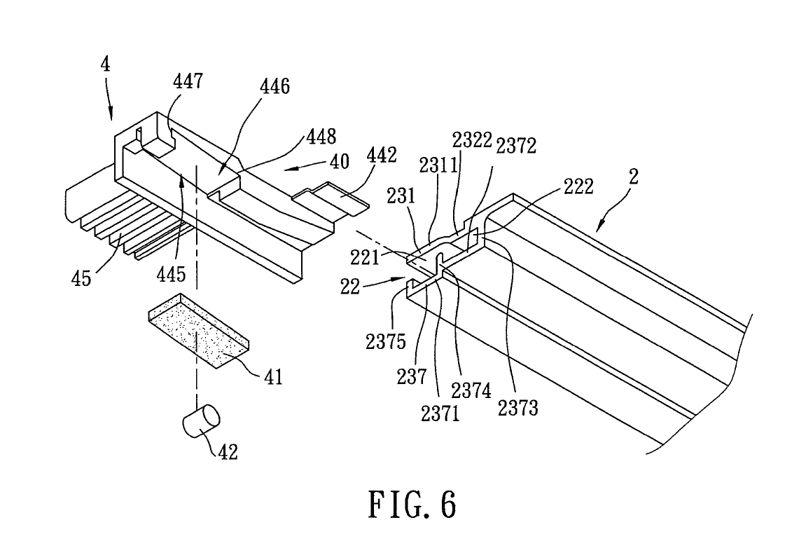

In the preferred embodiment, with particular reference to FIG. 6, each positioning unit 4 includes a slide member 40 that is made of a plastic material, and a lock member 42 that may be cylindrical in shape. The slide member 40 is mounted to a respective one of the peripheral edge portions of the screen 34 at the free end 342 of the screen 34, and extends into the recess 22 in a respective one of the rails 2 to be slidably disposed therein. The slide member 40 has an inclined surface 446 positioned in the recess 22. Each of the positioning units 4 further includes a deformable cushioning pad 41 interposed between the inclined surface 446 of the slide member 40 and the lock member 42. Each rail 2 includes an upper wall 231, and a lower wall 237 cooperating with the upper wall 231 to define the recess 22 therebetween. The lock member 42 of each of the positioning units 4 is disposed between the lower wall 237 of a respective one of the rails 2 and the cushioning pad 41, and is operable between a locked state where the lock member 42 is clamped between the lower wall 237 and the cushioning pad 41, and a released state where the lock member 42 is loosely held between the lower wall 237 and the cushioning pad 41. It should be noted that in some embodiments, the cushioning pad 41 may be omitted from the configuration, in which case the lock member 42 would be clamped between the inclined surface 446 and the lower wall 237 of the respective one of the rails 2.

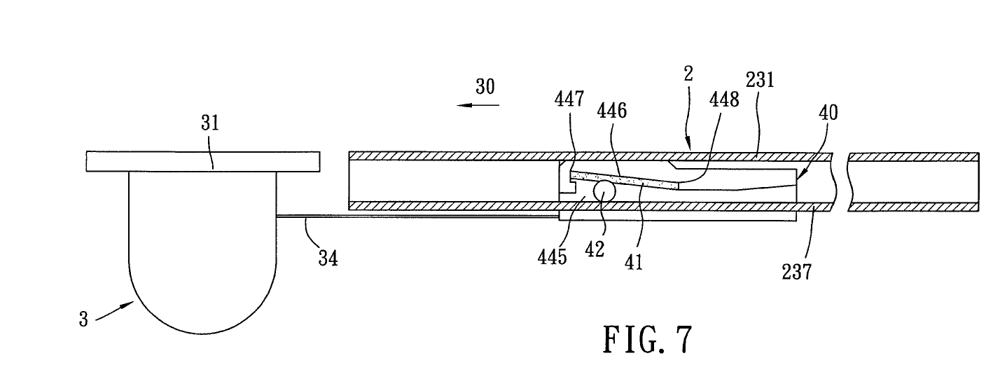

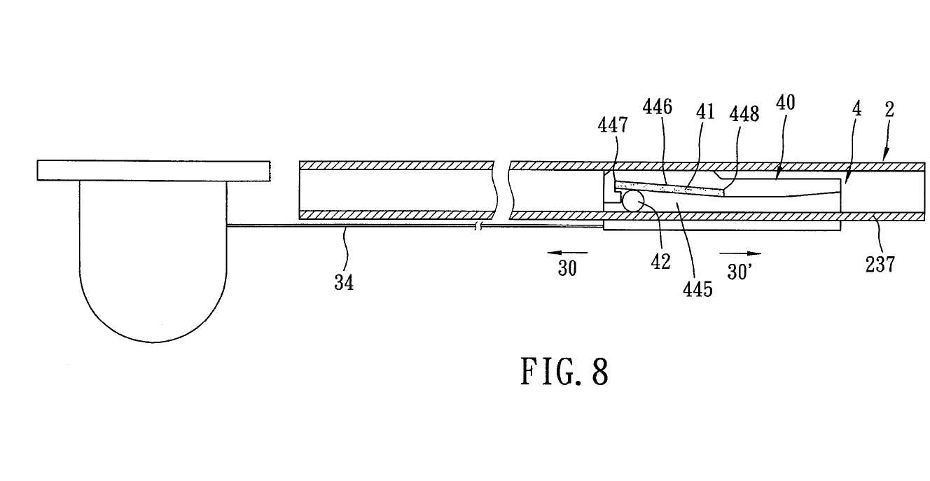

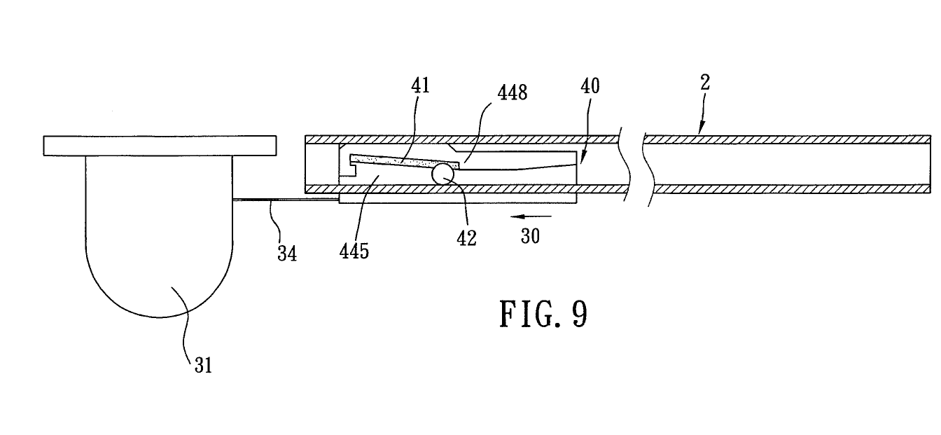

The inclined surface 446 of each of the slide members 40 has a high point 447 proximate to the roller 32 and a low point 448 distal from the roller 32. The inclined surface 446 is gradually sloped downward from the high point 447 to the low point 448. The inclined surface 446 of the slide member 40 faces the lower wall 237 of a respective one of the rails 2 to thereby form a gradually decreasing gap 445 (see also FIGS. 7 to 9) therewith from the high point 447 to the low point 448 of the inclined surface 446.

For each of the rails 2, the upper wall 231 has an inner section 2311 proximate to the screen 34 and an outer section 2322 distal from the screen 34, and the lower wall 237 has an inner section 2371 proximate to the screen 34, an outer section 2372 distal from the screen 34, a first vertical section 2373 interconnecting outer peripheries of the outer sections 2322, 2372 of the upper and lower walls 231, 237, a second vertical section 2374 extending upwardly toward the upper wall 231 between the inner and outer sections 2371, 2372 of the lower wall 237, and a third vertical section 2375 extending upwardly toward the upper wall 231 from an inner periphery of the inner section 2371 of the lower wall 237. The recess 22 has an inner space 221 defined among the inner sections 2311, 2371 of the upper and lower walls 231, 237 and the second and third vertical sections 2374, 2375 of the lower wall 237, and an outer space 222 defined among the outer sections 2322, 2372 of the upper and lower walls 231, 237 and the first and second vertical sections 2373, 2374 of the lower wall 237.

In the preferred embodiment, the slide member 40 of each of the positioning units 4 includes a balancing protrusion 442 extending into the outer space 222 of the recess 22 of a respective one of the rails 2. The balancing protrusion 442 is seated slidably on the second vertical section 2374 of the lower wall 237 of the respective one of the rails 2. Also, in the preferred embodiment, each of the positioning units 4 further includes a clasp 45 extending from the slide member 40 toward the screen 34 and secured to the respective one of the peripheral edge portions thereof at the free end 342 of the screen 34.

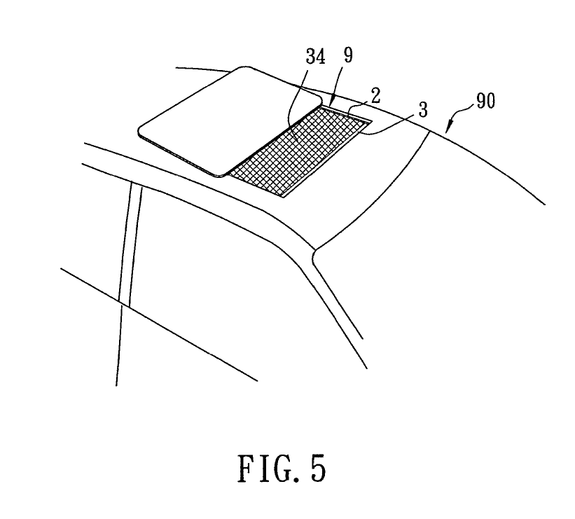

In the preferred embodiment of the present invention, the rails 2 are mounted on opposite sides of the sunroof 9 of the vehicle 90 (see FIG. 5). The roller 32 of the screen unit 3 is mounted next to the sunroof 9 through use of the fixtures 31 such that the roller 32 is substantially perpendicular to the rails 2.

Upon assembly, the lock members 42 are slidably disposed respectively in the gap 445. That is, the lock member 42 of each of the positioning units 4 is interposed between the cushioning pad 41 thereof and the lower wall 237 of a respective one of the rails 2. The roller 32 exerts the retraction force 30 on the screen 34 as described above. For each of the positioning units 4, when the slide member 40 is pulled in the direction of the retraction force 30, the lock member 42 of the positioning unit 4 gradually moves to urge against the inclined surface 446 between the high and low points 447, 448 thereof, as shown in FIG. 7. As a result, the positioning unit 4 is stopped, and therefore, the screen 34 is also stopped. Hence, the retraction force 30 exerted by the roller 32 acts on the positioning units 4 to automatically position the same, such that the screen 34 is maintained at any location where a user releases the screen 34.

Reference is now made to FIGS. 4, 7, and 8. When the user applies an extension force 30′ to the screen 34 in a direction which is opposite to the direction of the retraction force 30, the positioning units 4 move together with the screen 34. As a result, the lock members 42 are displaced to thereby correspond in location to the high points 447 of the inclined surfaces 446. As such, the lock members 42 are released, that is, the lock members 42 are no longer firmly clamped between the cushioning pads 41 and the lower walls 237. Once the extension force 30′ is released, the retraction force 30 exerted by roller 32 again acts on and positions the positioning units 4 so that the screen 34 is stopped as described above.

Now turning to FIGS. 4,7, and 9, when the user needs to retract the screen 34, the user must first overcome the resistance force arising from the lock members 42 being clamped between the inclined surfaces 446 and the lower walls 237 (i.e., between the cushioning pads 41 and the lower walls 237). That is, the user pushes the free end 342 of the screen 34 in a direction towards the roller 32 and with a sufficient force to overcome the resistance force arising from the clamping of the lock members 42. Consequently, the lock members 42 are displaced in the gaps 445 from areas corresponding to the high points 447 to areas corresponding to the low points 448 of the inclined surfaces 446. As a result, the frictional engagement forces become increasingly larger and as such, the user now requires a greater force to push against the screen 34 for retraction. That is, in the preferred embodiment, the extension of the screen 34 is obtained from a minimal effort, whereas a greater effort is required for the retraction of the screen 34.

The sunshade assembly of the preferred embodiment of the present invention has the following advantages:

1. A relatively simple structure is used to realize extension and retraction, as well as automatic positioning of the screen 34. Hence, assembly of the sunshade assembly is simplified.

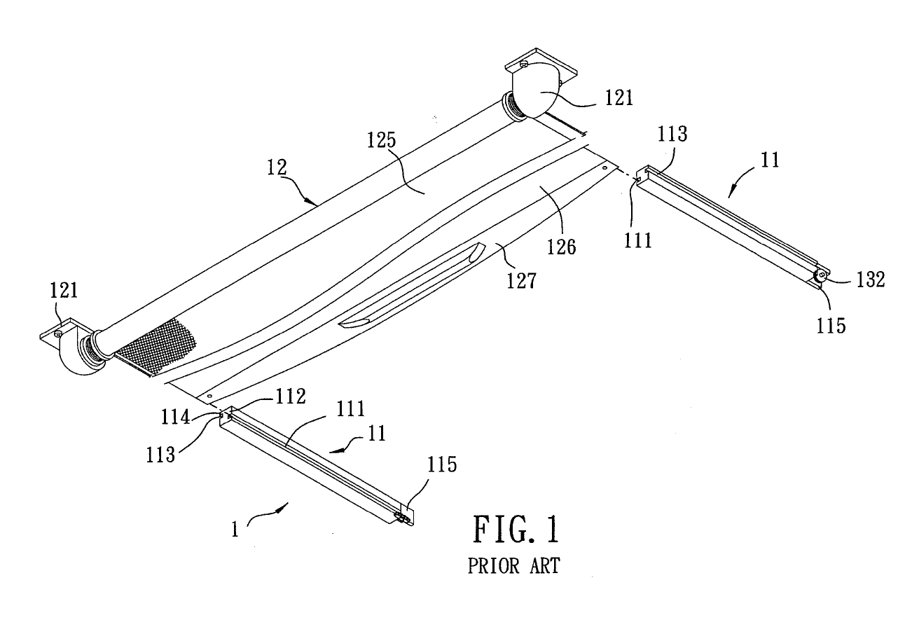

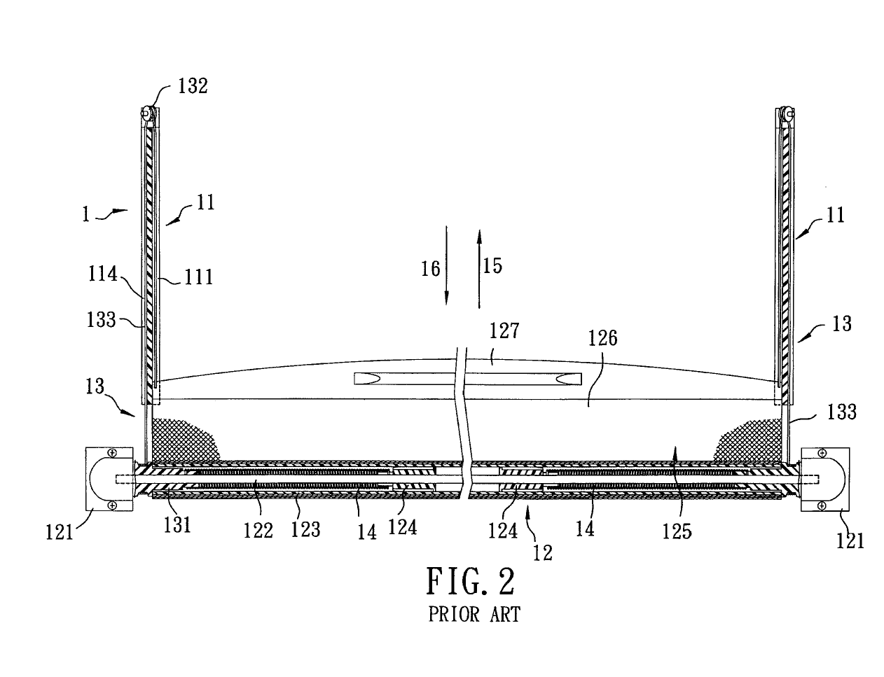

2. Unlike in the conventional sunshade assembly 1 shown in FIGS. 1 and 2, no rope is used in the present invention to interrelate elements and thereby effect extension, retraction, and automatic positioning of the screen 34. Hence, extension and retraction failures are less likely to occur.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A sunshade assembly adapted to be used on a sunroof of a vehicle, comprising:
a pair of rails each having an inner wall defining a recess therewithin;
a screen unit including
a roller operable to continuously exert a retraction force, and
a screen having a fixed end secured to said roller to thereby receive the retraction force, a free end opposite to said fixed end, and opposite peripheral edge portions; and
a pair of positioning units each including
a slide member mounted to a respective one of said peripheral edge portions of said screen at said free end of said screen and extending into said recess in a respective one of said rails to be slidably disposed therein, said slide member having an inclined surface positioned in said recess, and
a lock member disposed between said inclined surface of said slide member and said inner wall of the respective one of said rails, and operable between a locked state where said lock member is clamped between said inclined surface and said inner wall, and a released state where said lock member is loosely held between said inclined surface and said inner wall.

2. The sunshade assembly as claimed in claim 1, wherein said inclined surface of said slide member has a high point proximate to said roller and a low point distal from said roller, said inclined surface sloping gradually downward from said high point to said low point, and
each of said rails includes an upper wall, and a lower wall cooperating with said upper wall to define said recess therebetween, said inclined surface of said slide member facing said lower wall to thereby form a gradually decreasing gap therewith from said high point to said low point of said inclined surface,
said lock member being interposed between said inclined surface and said lower wall.

3. The sunshade assembly as claimed in claim 2, wherein each of said positioning units further includes a deformable cushioning pad interposed between said inclined surface of said slide member and said lock member.

4. The sunshade assembly as claimed in claim 3, wherein said upper wall has an inner section proximate to said screen and an outer section distal from said screen, and
said lower wall has an inner section proximate to said screen, an outer section distal from said screen, a first vertical section interconnecting outer peripheries of said outer sections of said upper and lower walls, a second vertical section extending upwardly toward said upper wall between said inner and outer sections of said lower wall, and a third vertical section extending upwardly toward said upper wall from an inner periphery of said inner section of said lower wall,
said recess having an inner space defined among said inner sections of said upper and lower walls and said second and third vertical sections of said lower wall, and an outer space defined among said outer sections of said upper and lower walls and said first and second vertical sections of said lower wall,
said slide member including a balancing protrusion extending into said outer space of said recess and being seated slidably on said second vertical section of said lower wall.

5. The sunshade assembly as claimed in claim 1, wherein each of said positioning units further includes a clasp extending from said slide member toward said screen and secured to the respective one of said peripheral edge portions thereof at said free end of said screen.

6. The sunshade assembly as claimed in claim 1, wherein each of said positioning units further includes a deformable cushioning pad interposed between said inclined surface of said slide member and said lock member.
